(19) United States
(12) Patent Application Publication
(10) Pub. No.: US 2015/0284289 A1
(43) Pub. Date: Oct. 8, 2015

(54) Sizing Compositions for Wet and Dry Filament Winding

(71) Applicant: PPG Industries Ohio, Inc., Cleveland, OH (US)

(72) Inventors: Pu Gu, Gastonia, NC (US); James C. Watson, Lake Wylie, SC (US); Langqiu Xu, Shelby, NC (US); Umesh C. Desai, Wexford, PA (US)

(21) Appl. No.: 14/675,909

(22) Filed: Apr. 1, 2015

Related U.S. Application Data
(60) Provisional application No. 61/975,472, filed on Apr. 4, 2014.

(51) Int. Cl. C03C 25/36; C03C 25/28

(52) U.S. Cl. CPC C03C 25/36; C03C 25/28

(57) ABSTRACT

Embodiments of the present invention relate to sizing compositions for glass fibers, fiber glass strands, and composites reinforced with fiber glass strands. In one embodiment, a sizing composition for glass fibers comprises a polyether carbamate. In another embodiment, such sizing compositions further comprise an alkylsilane. In yet other embodiments, such sizing compositions further comprise an aminofunctional siloxane. In an embodiment of the present invention, a sizing composition for glass fibers comprises a polyether carbamate, an alkylsilane, and an aminofunctional siloxane.

### CROSS-REFERENCE TO RELATED APPLICATIONS

This application claims priority to U.S. Provisional Patent Application Ser. No. 61/975,472, filed on Apr. 4, 2014, which is hereby incorporated by reference as though fully set forth herein.

### FIELD OF THE INVENTION

The present invention relates to sizing compositions for glass fibers and to fiber glass strands comprising a plurality of glass fibers at least partially coated with a sizing composition.

### BACKGROUND OF THE INVENTION

Various chemical treatments exist for glass-type surfaces such as glass fibers to aid in their processability and applications. Before bundling the filaments together after formation, a coating composition or sizing composition is applied to at least a portion of the surface of the individual filaments to protect them from abrasion and to assist in processing. As used herein, the terms “sizing composition,” “sizing,” “binder composition,” “binder,” or “size” refer to a coating composition applied to the filaments immediately after forming. Sizing compositions can provide protection through subsequent processing steps, such as those where the fibers pass by contact points as in the winding of the fibers and strands onto a forming package, drying the aqueous-based or solvent-based sizing composition to remove the water or solvent, twisting from one package to a bobbin, beaming to place the yarn onto very large packages ordinarily used as the warp in a fabric, chopping in a wet or dry condition, roving into larger bundles or groups of strands, unwinding for use as a reinforcement, weaving, and/or other downstream processes.

In addition, sizing compositions can play a dual role when placed on fibers that reinforce polymeric matrices in the production of fiber-reinforced plastics or in the reinforcement of other materials. In the reinforcement of polymeric matrices, the sizing composition can provide protection and also can provide compatibility between the fiber and the matrix polymer or resin. For instance, glass fibers in the forms of rovings, woven fabrics, nonwoven fabric, mats, chopped strands, and other forms have been used with resins, such as thermosetting and thermoplastic resins, for impregnation by, encapsulation by, or reinforcement of the resin. In such applications, it may be desirable to maximize the compatibility between the surface and the polymeric resin while also improving the ease of processability and manufacturability.

One exemplary application of glass fibers is in filament winding. In filament winding, continuous glass fibers in the form of rovings are impregnated with a resin and are wound around a steel mandrel until a desired thickness is reached to form a pipe. The resin used can depend on the properties desired in the end product, and certain components of the sizing composition on the glass fibers can be selected based on the resin system which is used. Examples of resins useful in such processes include epoxy resins.

It would be desirable to have new sizing compositions for fiber glass that can be used in a variety of applications such as, for example, filament winding applications.

### SUMMARY

Embodiments of the present invention relate to sizing compositions for glass fibers, fiber glass strands, and composites reinforced with fiber glass strands.

In some embodiments, a sizing composition for glass fibers comprises a polyether carbamate. Such sizing compositions, in some embodiments, further comprise an alkylsilane. In some embodiments, such sizing compositions further comprise an aminofunctional siloxane. A sizing composition for glass fibers, in some embodiments, comprises a polyether carbamate, an alkylsilane, and an aminofunctional siloxane.

The polyether carbamate, in some embodiments, comprises a reaction product of a polyoxyalkylene amine and a carbonate. In some embodiments, the polyoxyalkylene amine comprises a polyoxyalkylene diamine. In such embodiments, the polyoxyalkylene diamine can comprise a compound having the following structure (I):

H₂N[R¹—O]ₙ[R³—O]ₘ—R²—NH₂

wherein each R¹, R², and R³ can be the same or different and each can independently represent a C₂ to C₁₂ alkylene group, and wherein (n+m) is a value greater than 2. The polyoxyalkylene amine, in some embodiments, comprises polyetheramine. In some embodiments, the carbonate used to form the reaction product comprises propylene carbonate. The carbonate used to form the reaction product comprises cyclic propylene carbonate in some embodiments.

Sizing compositions of the present invention can comprise at least about 1 weight percent polyether carbamate on a total solids basis in some embodiments. In some embodiments, the sizing compositions comprise about 15 weight percent or less polyether carbamate on a total solids basis. The sizing compositions, in some embodiments, comprise about 5 weight percent or less polyether carbamate on a total solids basis. In some embodiments, the sizing compositions comprise between about 1 and about 5 weight percent polyether carbamate on a total solids basis.

In embodiments comprising an aminofunctional oligomeric siloxane, the aminofunctional oligomeric siloxane, in some embodiments, can comprise at least one alkyl group bonded to a first silicon atom and at least one amine bonded to a second silicon atom. Sizing compositions of the present invention can comprise at least about 0.1 weight percent aminofunctional oligomeric siloxane on a total solids basis in some embodiments. In some embodiments, the sizing compositions comprise about 15 weight percent or less aminofunctional oligomeric siloxane on a total solids basis. The sizing compositions, in some embodiments, comprise about 10 weight percent or less aminofunctional oligomeric siloxane on a total solids basis. In some embodiments, the sizing compositions comprise between about 0.1 and about 10 weight percent aminofunctional oligomeric siloxane on a total solids basis. The sizing compositions, in some embodiments, comprise between about 0.1 and about 2 weight percent aminofunctional oligomeric siloxane on a total solids basis.

In embodiments comprising an alkylsilane, the alkylsilane, in some embodiments, comprises a straight chain segment of at least 3 carbon atoms. In some embodiments, the alkylsilane comprises octyltriethoxysilane. Sizing compositions of the present invention can comprise at least about 1 weight percent alkylsilane on a total solids basis in some embodiments. In some embodiments, the sizing compositions comprise about 5 weight percent or less alkylsilane on a total solids basis. The sizing compositions, in some embodiments, comprise about 3 weight percent or less alkylsilane on a total solids basis. In some embodiments, the sizing compositions comprise between about 1 and about 5 weight percent alkylsilane on a total solids basis.

In some embodiments, sizing compositions of the present invention can further comprise a reactive modified siloxane polymer. The reactive modified siloxane polymer, in some embodiments, can comprise an organomodified dimethylsiloxane polymer. In some embodiments, the reactive modified siloxane polymer comprises epoxy functionalized siloxane polymer. The reactive modified siloxane polymer, in some embodiments, comprises at least 1 percent by weight of the sizing composition on a total solids basis. In some embodiments, the sizing compositions comprise about 10 weight percent or less reactive modified siloxane polymer on a total solids basis. The sizing compositions, in some embodiments, comprise about 8 weight percent or less reactive modified siloxane polymer on a total solids basis. In some embodiments, the sizing compositions comprise between about 1 and about 8 weight percent reactive modified siloxane polymer on a total solids basis.

As set forth below, various embodiments of sizing compositions according to the present invention can also include other components such as film formers, lubricants, other silanes, defoamers, wetting agents, etc.

In some embodiments, a sizing composition for glass fibers comprises a polyether carbamate in an amount of at least 1 weight percent of the sizing composition on a total solids basis, an alkylsilane in an amount of at least 1 weight percent of the sizing composition on a total solids basis, and an aminofunctional siloxane in an amount of at least 0.1 weight percent of the sizing composition on a total solids basis. A sizing composition for glass fibers, in some embodiments, comprises a polyether carbamate in an amount between about 1 and about 15 weight percent of the sizing composition on a total solids basis, an alkylsilane in an amount between about 1 and about 5 weight percent of the sizing composition on a total solids basis, and an aminofunctional siloxane in an amount between about 0.1 and about 15 weight percent of the sizing composition on a total solids basis.

Embodiments of the present invention also relate to glass fibers at least partially coated with sizing compositions of the present invention, fiber glass rovings comprising a plurality of glass fibers at least partially coated with sizing compositions of the present invention, composites comprising a polymer reinforced with a plurality glass fibers at least partially coated with sizing compositions of the present invention, and others as described in more detail below.

These and other embodiments of the present invention are described in greater detail in the Detailed Description which follows.

### DETAILED DESCRIPTION

For the purposes of this specification, unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in the following specification are approximations that can vary depending upon the desired properties sought to be obtained by the present invention. At the very least, and not as an attempt to limit the application of the doctrine of equivalents to any claims that might be filed in applications claiming priority to this application, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Additionally, any reference referred to as being “incorporated herein” is to be understood as being incorporated in its entirety.

It is further noted that, as used in this specification, the singular forms “a,” “an,” and “the” include plural referents unless expressly and unequivocally limited to one referent.

Further, when the phrase “up to” is used in connection with an amount of a component, material, or composition in the claims, it is to be understood that the component, material, or composition is present in at least a detectable amount (e.g., its presence can be determined) and may be present up to and including the specified amount.

The present invention relates, in one aspect, to sizing compositions for fiber glass. As used herein, the term “sizing composition” refers to a coating composition applied to fiber glass filaments immediately after forming and may be used interchangeably with the terms “binder composition,” “binder,” “sizing,” and “size.” The sizing compositions described herein generally relate to aqueous sizing compositions. In non-limiting embodiments, the sizing compositions are useful on fiber glass to be used in various applications such as the reinforcement of polymers. One exemplary use for such glass fibers is in filament winding. Other non-limiting embodiments of the present invention relate to fiber glass strands or rovings coated with the sizing compositions. Other non-limiting embodiments of the present invention relate to products that incorporate fiber glass strands or rovings.

The present invention will be discussed generally in the context of its use in the production, assembly, and application of glass fibers. However, one of ordinary skill in the art would understand that the present invention may be useful in the processing of other textile materials.

Persons of ordinary skill in the art will recognize that the present invention can be implemented in the production, assembly, and application of a number of glass fibers. Non-limiting examples of glass fibers suitable for use in the present invention can include those prepared from fiberizable glass compositions such as “E-glass”, “A-glass”, “C-glass”, “S-glass”, “ECR-glass” (corrosion resistant glass), and fluorine and/or boron-free derivatives thereof. Typical formulations of glass fibers are disclosed in K. Loewenstein, The Manufacturing Technology of Continuous Glass Fibres, (3d Ed. 1993). The present invention is particularly useful in the production, assembly, and application of glass fibers prepared from E-glass compositions.

Embodiments of the present invention provide fiber glass strands having properties that make the fiber glass strands desirable for certain processes, applications, and/or end uses. For examples, in some embodiments, fiber glass strands of the present invention are particularly useful in filament winding (wet and/or dry filament winding) applications. In some embodiments of the present invention, a fiber glass strand comprises at least one glass fiber at least partially coated with a sizing composition of the present invention. Fiber glass strands, in some embodiments, can have one or more desirable properties including, without limitation, good performance in filament winding, good interaction with a resin to be reinforced, desirable tensile strength, desirable hydrolysis resistance, minimal fuzz in downstream applications, desirable wetting characteristics, and/or other properties.

Referring now to sizing compositions according to various embodiments of the present invention, in some embodiments, a sizing composition for glass fibers comprises a polyether carbamate. Such sizing compositions, in some embodiments, further comprise an alkylsilane. In some embodiments, such sizing compositions further comprise an aminofunctional siloxane. A sizing composition for glass fibers, in some embodiments, comprises a polyether carbamate, an alkylsilane, and an aminofunctional siloxane. In some embodiments, sizing compositions of the present invention can further comprise a reactive modified siloxane polymer. As set forth below, various embodiments of sizing compositions according to the present invention can also include other components such as film formers, lubricants, other silanes, defoamers, wetting agents, etc. Relative amounts of such components that can be used in various embodiments are also discussed in more detail below.

One component of sizing compositions of the present invention is polyether carbamate. In certain embodiments, the polyether carbamate compound is the reaction product of a polyoxyalkylene amine and a carbonate, such as a linear or cyclic carbonate. Suitable polyoxyalkylene amines that may be used include, without limitation, polyoxyalkylene monoamines, polyoxyalkylene diamines, polyoxyalkylene triamines, polyoxy tetramine, or combinations thereof. In certain embodiments, a polyoxyalkylene diamine comprises a compound having the following structure (I):

H₂N[R¹—O]ₙ[R³—O]ₘ—R²—NH₂

wherein each R¹, R², and R³ can be the same or different and each can independently represent a C₂ to C₁₂ alkylene group, and wherein (n+m) is a value greater than 2.

Suitable cyclic carbonates that may be used for the polyether carbamate compound include, without limitation, ethylene carbonate, propylene carbonate, butylene carbonate, glycerine carbonate, or combinations thereof.

In some embodiments, the polyether carbamate compound is made by charging a suitable reaction vessel with the polyoxyalkylene amine and the cyclic carbonate. In some embodiments, the polyoxyalkylene amine and the cyclic carbonate are used in amounts that are sufficient to yield an equivalents ratio of polyoxyalkylene amine to cyclic carbonate ranging from 1:0.5 to 1:1.15. The reaction vessel is then heated to a temperature ranging from 20° C. to 150° C. for a time period ranging from 1 hour to 10 hours thereby forming the polyether carbamate compound.

As an example, in some embodiments, the polyether carbamate can be the reaction product of propylene carbonate and JEFFAMINE D-400 (a polyetheramine commercially available from Huntsman International LLC) prepared pursuant to Example A of U.S. Pat. No. 7,288,595, which is hereby incorporated by reference.

Sizing compositions of the present invention can comprise at least about 1 weight percent polyether carbamate on a total solids basis in some embodiments. In some embodiments, the sizing compositions comprise about 15 weight percent or less polyether carbamate on a total solids basis. The sizing compositions, in some embodiments, comprise about 5 weight percent or less polyether carbamate on a total solids basis. In some embodiments, the sizing compositions comprise between about 1 and about 5 weight percent polyether carbamate on a total solids basis.

In some embodiments, sizing compositions of the present invention comprise an aminofunctional oligomeric siloxane. The aminofunctional oligomeric siloxane, in some embodiments, can comprise at least one alkyl group bonded to a first silicon atom and at least one amine bonded to a second silicon atom. Examples of commercially available aminofunctional oligomeric siloxanes that can be used in embodiments of the present invention include HYDROSIL® 2909, HYDROSIL® 2627, and HYDROSIL® 2776, each of which are commercially available from Evonik Industries, Inc.

The amount of aminofunctional oligomeric siloxane that can be used in various embodiments of the present invention, can depend on a number of factors including, without limitation, processing parameters in the forming process (e.g., forming of glass fibers), processing parameters in downstream processing (e.g., formation of products incorporating glass fibers, such as pipe formed by filament winding), and others. As to the amount of the aminofunctional oligomeric siloxane in embodiments of sizing compositions of the present invention, an aminofunctional oligomeric siloxane comprises at least about 0.1 percent by weight of the sizing composition on a total solids basis in some embodiments. In some embodiments, the sizing compositions comprise about 15 weight percent or less aminofunctional oligomeric siloxane on a total solids basis. The sizing compositions, in some embodiments, comprise about 10 weight percent or less aminofunctional oligomeric siloxane on a total solids basis. In some embodiments, the sizing compositions comprise between about 0.1 and about 10 weight percent aminofunctional oligomeric siloxane on a total solids basis. The sizing compositions, in some embodiments, comprise between about 0.1 and about 2 weight percent aminofunctional oligomeric siloxane on a total solids basis.

In embodiments comprising an alkylsilane, the alkylsilane, in such embodiments, comprises a straight chain segment of at least 3 carbon atoms. In some embodiments, the alkylsilane can comprise a straight chain segment of 3 to 10 carbon atoms. In some embodiments, the alkylsilane comprises octyltriethoxysilane. Examples of commercially available alkylsilanes that can be used in embodiments of the present invention include DYNASYLAN SIVO 850, DYNASYLAN PTMO, and Protectosil AQUA-TRETE 40, each of which are commercially available from Evonik Industries, Inc.

The amount of alkylsilane that can be used in various embodiments of the present invention, can depend on a number of factors including, without limitation, processing parameters in the forming process (e.g., forming of glass fibers), processing parameters in downstream processing (e.g., formation of products incorporating glass fibers, such as pipe formed by filament winding), potential interference with interaction between other components in the sizing composition and the resin to be reinforced, and others. As to the amount of the alkylsilane in embodiments of sizing compositions of the present invention, such sizing compositions can comprise at least about 1 weight percent alkylsilane on a total solids basis in some embodiments. In some embodiments, the sizing compositions comprise about 5 weight percent or less alkylsilane on a total solids basis. The sizing compositions, in some embodiments, comprise about 3 weight percent or less alkylsilane on a total solids basis. In some embodiments, the sizing compositions comprise between about 1 and about 5 weight percent alkylsilane on a total solids basis.

In some embodiments, sizing compositions of the present invention can further comprise a reactive modified siloxane polymer. The reactive modified siloxane polymer, in some embodiments, can comprise an organomodified dimethylsiloxane polymer. In some embodiments, the reactive modified siloxane polymer comprises epoxy functionalized siloxane polymer. Examples of commercially available reactive modified siloxane polymer that can be used in embodiments of the present invention include COATOSIL 9300, which is an organomodified polydimethylsiloxane emulsion commercially available from Momentive Performance Materials Inc., SM 8715 EX, which is an epoxyfunctional siloxane emulsion commercially available from Dow Corning Corporation.

The amount of reactive modified siloxane polymer that can be used in various embodiments of the present invention, can depend on a number of factors including, without limitation, processing parameters in the forming process (e.g., forming of glass fibers), processing parameters in downstream processing (e.g., formation of products incorporating glass fibers, such as pipe formed by filament winding), potential interference or interaction between other components in the sizing composition and the resin to be reinforced, and others. In some embodiments, it may be desirable not to include any reactive modified siloxane polymer. For example, in dry filament winding manufacturing processes, the inclusion of certain reactive modified siloxane polymers in some embodiments of sizing compositions can leave a sticky film on the tensioning bars leading to excessive winding tension in some instances.

As to the amount of the reactive modified siloxane polymer in embodiments of sizing compositions of the present invention, the reactive modified siloxane polymer, in some embodiments, comprises at least 1 percent by weight of the sizing composition on a total solids basis. In some embodiments, the sizing compositions comprise about 15 weight percent or less reactive modified siloxane polymer on a total solids basis. The sizing compositions, in some embodiments, comprise about 10 weight percent or less reactive modified siloxane polymer on a total solids basis. In some embodiments, the sizing compositions comprise between about 1 and about 10 weight percent reactive modified siloxane polymer on a total solids basis. The sizing composition, in some embodiments, comprises between about 3 and about 8 weight percent reactive modified siloxane polymer on a total solids basis.

Various embodiments of sizing compositions according to the present invention can also include other components such as film formers, lubricants, other silanes, defoamers, wetting agents, etc.

With regard to film-formers, sizing compositions of the present invention can include one or more film-formers. In general, any film-former known to those of skill in the art to be useful in sizing compositions can be used. In some embodiments, sizing compositions of the present invention can comprise a plurality of film formers. Persons of skill in the art can select the one or more film-formers based on a number of factors including, for example, the intended use of the glass fibers, the other components of the sizing composition, the polymer or other material to be reinforced with the glass fibers, properties of the fibers to be sized, and others. For example, if the glass fibers are to be used in the reinforcement of a particular polymer, the film-former can be selected to be compatible with that polymer (or not to negatively interfere with the reinforcement of that polymer).

A number of film formers can used in various embodiments of the present invention. Non-limiting examples of film formers that can be used in various embodiments of the present invention comprise epoxies, polyvinylpyrrolidones, polyesters, polyurethanes, or mixtures, or copolymers, or aqueous dispersions thereof.

In some embodiments, the at least one film-former comprises an epoxy polymer. One non-limiting example of an epoxy polymer that can be used in some embodiments is EPI-REZ 3514-W56, from Momentive Specialty Chemicals Inc., which is an aqueous dispersion of an epoxy resin having an epoxy equivalent weight of 205-225 g/eq. Another non-limiting example of an epoxy polymer that can be used in some embodiments is EPON 828, from Momentive Specialty Chemicals Inc., which is an epoxy resin having an epoxy equivalent weight of 185-192 g/eq. Other non-limiting examples of epoxy polymers that can be used include, without limitation, EPI-REZ 3515-W-60 from Momentive Specialty Chemicals Inc., which is an aqueous dispersion of a bisphenol A epoxy resin with an equivalent weight of 220-260 g/eq, and EPI-REZ 3522-W-60 from Momentive Specialty Chemicals Inc., which is an aqueous dispersion of a solid bisphenol A epoxy resin 550-650 g/eq. Depending on how an epoxy film-former is provided, one or more surfactants or emulsifying agents may need to be added to an epoxy emulsion in order to stabilize it in preparing a sizing composition. Other epoxy film-formers are provided as emulsions with one or more surfactants already included. Persons of ordinary skill in the art can determine whether one or more surfactants or emulsifying agents may need to be added to an epoxy emulsion based on the particular emulsion used.

Another example of a film-former that can be used in some embodiments of the present invention is polyvinylpyrrolidone. One non-limiting example of a polyvinylpyrrolidone that can be used in some embodiments of the present invention is polyvinylpyrrolidone K-30, which is commercially available from a variety of suppliers. Other non-limiting examples of polyvinylpyrrolidone that can be used include, without limitation, polyvinylpyrrolidone K-15 and polyvinylpyrrolidone K-90, which are commercially available from a variety of suppliers.

As indicated above, sizing compositions according to various embodiments of the present invention can include one film-former or combinations of film-formers and should not be understood to be limited to only those specifically identified herein.

In some embodiments, the one or more film-formers are generally present in the sizing composition in an amount of about 50 percent or more by weight of the sizing composition on a total solids basis. The one or more film-formers, in some embodiments, can be present in the sizing composition, in an amount of about 90 percent or less by weight of the sizing composition on a total solids basis. The one or more film-formers, in some embodiments, can be present in the sizing composition, in an amount of about 60 percent or more by weight of the sizing composition on a total solids basis. In some embodiments, the one or more film-formers can be present in the sizing composition, in an amount of about 70 percent or more by weight of the sizing composition on a total solids basis. The one or more film-formers, in some embodiments, can be present in the sizing composition in an amount between about 60 percent and about 90 percent by weight of the sizing composition on a total solids basis.

As noted above, depending on the particular film-former used, one or more emulsifying agents or surfactants may be used to assist in dispersing the film-former in water or an aqueous solution. Emulsifying agents can also assist in emulsifying or dispersing other components of the sizing compositions in some embodiments. Non-limiting examples of suitable emulsifying agents can include polyoxyalkylene block copolymers, ethoxylated alkyl phenols, polyoxyethylene octylphenyl glycol ethers, ethylene oxide derivatives of sorbitol esters, polyoxyethylated vegetable oils, ethoxylated alkylphenols, and nonylphenol surfactants. Examples of commercially available emulsifying agents useful in embodiments of the present invention can include Pluronic F-108, which is a polyoxyalkylene block copolymer and which is commercially available from BASF Corp., Alkamuls EL-719, which is an ethoxylated castor oil and which is commercially available from Rhodia, and Lutensol OP-10, which is an octylphenol ethoxylate and which is commercially available from BASF Corp.

As indicated above, embodiments of the present invention can utilize one or more emulsifying agents or surfactants. Multiple emulsifying agent can be used in some embodiments to assist in providing a more stable emulsion. Multiple emulsifying agents can be used in amounts effective to disperse hydrophobic components, such as certain film-formers, in water or an aqueous solution. In some non-limiting embodiments of sizing compositions that include one or more emulsifying agents or surfactants, the total amount of emulsifying agents or surfactants can comprise up to twenty (20) weight percent of the sizing composition based on total solids. In other non-limiting embodiments, the total amount of emulsifying agents can comprise up to seventeen (17) weight percent of the sizing composition based on total solids. In other non-limiting embodiments, the total amount of emulsifying agents can comprise up to sixteen (16) weight percent of the sizing composition based on total solids. In some embodiments, the total amount of emulsifying agents can comprise ten (10) or more weight percent of the sizing composition based on total solids. The total amount of emulsifying agents, in some embodiments, can comprise between ten (10) and twenty (20) weight percent of the sizing composition based on total solids.

Turning now to coupling agents, some embodiments of the present invention can further comprise one or more coupling agents. Non-limiting examples of coupling agents that can be used in the sizing compositions of the present invention include organo-silane coupling agents, transition metal coupling agents, amino-containing Werner coupling agents, chrome coupling agents, and mixtures thereof. These coupling agents typically have multiple functionalities. Each metal or silicon atom has attached to it one or more groups which can react with the glass fiber surface or otherwise be chemically attracted, but not necessarily bonded, to the glass fiber surface. A coupling agent also interacts and/or reacts with a resin or resins that may be used in an end product, such that the coupling agent facilitates adhesion between the glass fibers and the resin or resins.

Some embodiments of sizing compositions of the present invention can comprise organo-silane coupling agents. Non-limiting examples of suitable organo-silane coupling agents include Silquest A-187 gamma-glycidoxypropyltrimethoxysilane, Silquest A-1100 gamma-aminopropyltriethoxysilane, Silquest A-174 gamma-methacryloxypropyltrimethoxysilane, and Silquest A-1120 N-(beta-aminoethyl)-gamma-aminopropyltrimethoxysilane, each of which is commercially available from Momentive Performance Materials Inc., as well as DYNASYLAN® GLYMO 3-glycidyloxypropyltrimethoxysilane, DYNASYLAN® MEMO 3-methacryloxypropyl-trimethoxysilane, and DYNASYLAN® AMEO 3-aminopropyltriethoxysilane, each of which is commercially available from Evonik Industries. In one non-limiting embodiment, a 3-glycidyloxypropyltrimethoxysilane, such as DYNASYLAN® GLYMO, may be used in sizing compositions of the present invention. Other organo-silanes or combinations of organo-silanes suitable can also be used depending on the particular application.

In some embodiments, the one or more coupling agents are generally present in the sizing composition in an amount of about 1 percent or more by weight of the sizing composition on a total solids basis. The one or more coupling agents, in some embodiments, can be present in the sizing composition, in an amount of about 3 percent or more by weight of the sizing composition on a total solids basis in some embodiments. The one or more coupling agents, in some embodiments, can be present in the sizing composition, in an amount of about 15 percent or less by weight of the sizing composition on a total solids basis. In some embodiments, the one or more coupling agents, in some embodiments, can be present in the sizing composition, in an amount of about 10 percent or less by weight of the sizing composition on a total solids basis. The one or more coupling agents, in some embodiments, can be present in the sizing composition, in an amount of about 8 percent or less by weight of the sizing composition on a total solids basis. The one or more coupling agents, in some embodiments, can be present in the sizing composition in an amount between about 1 percent and about 10 percent by weight of the sizing composition on a total solids basis. In some embodiments, the one or more coupling agents can be present in the sizing composition in an amount between about 3 percent and about 3 percent by weight of the sizing composition on a total solids basis.

In one non-limiting embodiment, a sizing composition of the present invention may further comprise at least one lubricant. Lubricants can be used, for example, in sizing compositions of the present invention to assist with internal lubrication (e.g., fiber-to-fiber abrasion) and to assist with external lubrication (e.g., glass-to-contact point abrasion). Lubricants can be selected for use in embodiments of the present invention to provide such properties to the sizing composition. In some non-limiting embodiments, the at least one lubricant may comprise at least one cationic lubricant. In some non-limiting embodiments, the at least one lubricant may comprise at least one non-ionic lubricant. In other embodiments, the at least one lubricant may comprise at least one cationic lubricant and at least one nonionic lubricant.

Cationic lubricants may be used in embodiments of the present invention, for example, to assist with internal lubrication, such as by reducing filament-to-filament or glass-to-glass abrasion. In general, most cationic lubricants known to those of skill in the art can be used in various embodiments of the present invention. Non-limiting examples of cationic lubricants suitable in the present invention include lubricants with amine groups, lubricants with ethoxylated amine oxides, and lubricants with ethoxylated fatty amides. One non-limiting example of a lubricant with an amine group is a modified polyethylene amine, e.g. KATAX 6717L, which is a partially amidated polyethylene imine commercially available from Pulcra Chemicals of Rock Hill, S.C. Another example of a cationic lubricant useful in embodiments of the present invention is ALUBRASPIN 226, which is a partially amidated polyethylene imine commercially available from BASF Corp. of Parsippany, N.J.

In one non-limiting embodiment of a sizing composition utilizing a cationic lubricant, the amount of cationic lubricant can comprise up to ten (10) weight percent of the sizing composition based on total solids. In another non-limiting embodiment, the amount of cationic lubricant can comprise 0.3 weight percent or more of the sizing composition based on total solids. The amount of cationic lubricant, in another non-limiting embodiment, can comprise between 0.3 and eight (8) weight percent of the sizing composition based on total solids. In a further non-limiting embodiment, the amount of cationic lubricant can comprise between 0.3 and five (5) weight percent of the sizing composition based on total solids. The amount of cationic lubricant, in another non-limiting embodiment, can comprise between 0.3 and three (3) weight percent of the sizing composition based on total solids.

In some embodiments, sizing compositions of the present invention may also comprise at least one nonionic lubricant. Nonionic lubricants useful in the present invention may advantageously reduce yarn friction, increase lubrication, protect against glass-to-contact point abrasion during manufacture and in downstream processing (e.g., at a customer of a fiber glass manufacturer), etc. For example, nonionic lubricants useful in the present invention may reduce fiber to metal friction during manufacture and processing.

Examples of non-ionic lubricants useful in some embodiments of the present invention can include ethoxylated fatty alcohols, such as ethoxylated oleates (including, for example, monooleates and di-oleates), ethoxylated laurates (including for, example, monolaurates and di-laurates) and ethoxylated tallates (including, for example, monotallates and di-tallates). One non-limiting example of a suitable ethoxylated laurate that can be used as a non-ionic lubricant in some embodiments of the present invention is Standapol 2661, commercially available from Pulcra Chemicals. Standapol 2661 is a polyethylene glycol monolaurate having an average molecular weight of 600. A non-limiting example of a suitable polyethylene glycol ester that can be used as a non-ionic lubricant in some embodiments of the present invention is MAPEG 400 DO, commercially available from BASF Corporation. MAPEG 400 DO is a polyethylene glycol di-oleate having an average molecular weight of 400. An example of a suitable ethoxylated di-tallate is available from BASF Corporation under the product name MAPEG 600 DOT. MAPEG 600 DOT is a polyethylene glycol di-tallate having an average molecular weight of 600. An example of a suitable ethoxylated di-laurate is available from BASF Corporation under the product name MAPEG 400 ML PEG Ester. MAPEG 400 ML PEG Ester is a polyethylene glycol monolaurate having an average molecular weight of 400. Other examples of ethoxylated oleates, laurates, and tallates are also available from BASF Corporation under the MAPEG product line.

In some non-limitings embodiment, the nonionic lubricant may comprise at least one wax. Examples of waxes suitable for use in some embodiments of the present invention include polyethylene wax, paraffin wax, polypropylene wax, microcrystalline waxes, and oxidized derivatives of these waxes. One example of a polyethylene wax suitable for use in some embodiments of the present invention is Protolube HD-A, which is a high density polyethylene wax commercially available from Bayer Corporation of Pittsburgh, Pa. Examples of a paraffin wax suitable in some embodiments of the present invention include Elon PW, which is a paraffin wax emulsion commercially available from Elon Specialties of Concord, N.C., and Michem Lube 723 which is a parrafin wax emulsion commercially available from Michelman, Inc.

Other nonionic lubricants, aside from waxes, could also be used. In selecting nonionic lubricants other than the waxes discussed above, compatibility with the other components of the sizing composition is an important consideration. For example, some oils may be used as nonionic lubricants in some embodiments. Examples of suitable oils can include triglyceride oils and partially hydrogenated oils based on palm, coconut, soybean, etc.

The amount of the at least one nonionic lubricant in some sizing compositions of the present invention can be up to ten (10) weight percent of the sizing composition on a total solids basis. In some embodiments, the amount of nonionic lubricant can be up to eight (8) weight percent of the sizing composition on a total solids basis. In some embodiments, the amount of nonionic lubricant can be between one (1) and six (6) weight percent of the sizing composition on a total solids basis. In some embodiments, the amount of nonionic lubricant can be between two (2) and five (5) weight percent of the sizing composition on a total solids basis.

Anti-foaming agents can be used in non-limiting embodiments of the present invention to control foaming of the sizing composition. A non-limiting example of an anti-foaming agent suitable for use in some embodiments of the present invention is SAG 10 defoamer, which is a silicon-based antifoam emulsion from OSi Specialties of Tarrytown, N.Y. Other defoamers known to those of skill in the art could also be used in some embodiments.

In some embodiments, a sizing composition for glass fibers comprises a polyether carbamate in an amount of at least 1 weight percent of the sizing composition on a total solids basis, an alkylsilane in an amount of at least 1 weight percent of the sizing composition on a total solids basis, and an aminofunctional siloxane in an amount of at least 0.1 weight percent of the sizing composition on a total solids basis. A sizing composition for glass fibers, in some embodiments, comprises a polyether carbamate in an amount between about 1 and about 15 weight percent of the sizing composition on a total solids basis, an alkylsilane in an amount between about 1 and about 5 weight percent of the sizing composition on a total solids basis, and an aminofunctional siloxane in an amount between about 0.1 and about 5 weight percent of the sizing composition on a total solids basis. In some embodiments, a sizing composition for glass fibers comprises a polyether carbamate in an amount between about 1 and about 5 weight percent of the sizing composition on a total solids basis, an alkylsilane in an amount between about 1 and about 3 weight percent of the sizing composition on a total solids basis, and an aminofunctional siloxane in an amount between about 0.1 and about 2 weight percent of the sizing composition on a total solids basis. In some embodiments, such sizing compositions can further comprise a reactive modified siloxane in an amount of at least 1 weight percent, in an amount between about 1 and about 10 weight percent, or in an amount between about 3 and about 8 weight percent on a total solids basis. In some embodiments, such sizing compositions can further comprise at least one coupling agent, such as an organosilane, in an amount of at least 1 weight percent, in an amount between about 1 and about 15 weight percent, or in an amount between about 1 and about 10 weight percent on a total solids basis. Such sizing compositions, in some embodiments, can further comprise at least one film-former in an amount of at least 50 weight percent, in an amount of at least about 60 weight percent, or in an amount between about 60 and about 90 weight percent on a total solids basis.

Some embodiments of sizing compositions of the present invention comprise a polyether carbamate in an amount of at least 1 weight percent of the sizing composition on a total solids basis, an alkylsilane in an amount of at least 1 weight percent of the sizing composition on a total solids basis, an aminofunctional siloxane in an amount of at least 0.1 weight percent of the sizing composition on a total solids basis, at least one coupling agent in an amount of at least 1 weight percent on a total solids basis, and at least one film-former in an amount of at least 50 weight percent on a total solids basis.

Sizing compositions for glass fibers, in some embodiments, comprise a polyether carbamate in an amount between about 1 and about 15 weight percent of the sizing composition on a total solids basis, an alkylsilane in an amount between about 1 and about 5 weight percent of the sizing composition on a total solids basis, an aminofunctional siloxane in an amount between about 0.1 and about 5 weight percent of the sizing composition on a total solids basis, at least one coupling agent in an amount between about 1 and about 15 weight percent on a total solids basis, and at least one film-former in an amount of at least about 60 weight percent on a total solids basis.

In some embodiments, a sizing composition for glass fibers comprises a polyether carbamate in an amount between about 1 and about 5 weight percent of the sizing composition on a total solids basis, an alkylsilane in an amount between about 1 and about 3 weight percent of the sizing composition on a total solids basis, an aminofunctional siloxane in an amount between about 0.1 and about 2 weight percent of the sizing composition on a total solids basis, at least one coupling agent in an amount between about 1 and about 10 weight percent on a total solids basis, and at least one film-former in an amount between about 60 and about 90 weight percent on a total solids basis.

Some embodiments of sizing compositions of the present invention comprise a polyether carbamate in an amount of at least 1 weight percent of the sizing composition on a total solids basis, an alkylsilane in an amount of at least 1 weight percent of the sizing composition on a total solids basis, an aminofunctional siloxane in an amount of at least 0.1 weight percent of the sizing composition on a total solids basis, a reactive modified siloxane in an amount of at least 1 weight percent on a total solids basis, at least one coupling agent in an amount of at least 1 weight percent on a total solids basis, and at least one film-former in an amount of at least 50 weight percent on a total solids basis.

Sizing compositions for glass fibers, in some embodiments, comprise a polyether carbamate in an amount between about 1 and about 15 weight percent of the sizing composition on a total solids basis, an alkylsilane in an amount between about 1 and about 5 weight percent of the sizing composition on a total solids basis, an aminofunctional siloxane in an amount between about 0.1 and about 5 weight percent of the sizing composition on a total solids basis, a reactive modified siloxane in an amount between about 1 and about 10 weight percent on a total solids basis, at least one coupling agent in an amount between about 1 and about 15 weight percent on a total solids basis, and at least one film-former in an amount of at least about 60 weight percent on a total solids basis.

In some embodiments, a sizing composition for glass fibers comprises a polyether carbamate in an amount between about 1 and about 5 weight percent of the sizing composition on a total solids basis, an alkylsilane in an amount between about 1 and about 3 weight percent of the sizing composition on a total solids basis, an aminofunctional siloxane in an amount between about 0.1 and about 2 weight percent of the sizing composition on a total solids basis, a reactive modified siloxane in an amount between about 3 and about 8 weight percent on a total solids basis, at least one coupling agent in an amount between about 1 and about 10 weight percent on a total solids basis, and at least one film-former in an amount between about 60 and about 90 weight percent on a total solids basis.

Embodiments of the present invention also relate to fiber glass strands and fiber glass rovings comprising at least one glass fiber at least partially coated with an embodiment of a sizing composition of the present invention. Such embodiments of fiber glass strands can include glass fibers at least partially coated with any of the sizing compositions described herein. Glass fibers are produced by flowing molten glass via gravity through a multitude of small openings in a precious metal device, called a bushing. After the fibers have cooled very shortly after their issuance from the bushing and usually in close proximity to the bushing, these fibers are at least partially coated with a sizing composition of the present invention. The sizing composition can be applied by sprayers, rollers, belts, metering devices, or other similar application devices. The sized glass fibers are gathered into strands comprising a plurality of individual fibers, generally from 200 to more than 4000.

After their formation and treatment, the strands are typically wound into a “forming package.” The strands can be wound onto a paper or plastic tube using a winder. The forming packages are usually dried in either an oven or at room temperature to remove some of the moisture from the fibers. Additional information related to fiberizable glass compositions and methods of making glass filaments are disclosed in K. Loewenstein, The Manufacturing Technology of Glass Fibres, (3d Ed. 1993) at pages 30-44, 47-60, 115-122 and 126-135, which are hereby incorporated by reference. For some applications, the strands are later wound onto a bobbin via conventional textile twisting techniques such as a twist frame. For other applications, the strands are not twisted and/or wound onto a bobbin.

The amount of sizing composition on the strand may be measured as “loss on ignition” or “LOI”. As used herein, the term “loss on ignition” or “LOI” means the weight percent of dried sizing composition present on the fiber glass as determined by Equation 1:

LOI=100×[(W_{dry}−W_{bare})/W_{dry}] (Eq. 1)

wherein W_{dry} is the weight of the fiber glass plus the weight of the coating after drying in an oven at 220° F. (about 104° C.) for 60 minutes, and W_{bare} is the weight of the bare fiber glass after heating the fiber glass in an oven at 1150° F. (about 621° C.) for 20 minutes and cooling to room temperature in a dessicator.

In general, although not limiting, the loss on ignition (LOI) of embodiments of fiber glass strands of the present invention may be up to 2 percent. In other non-limiting embodiments, the LOI can be up to 1.5 percent. In further non-limiting embodiments, the LOI can be up to 1 percent. At lower LOI levels, the broken filament levels of a fiber glass product can increase. However, increasing the LOI increases production costs. Thus, in some non-limiting embodiments, the LOI can be between 0.4 and 1 weight percent.

In non-limiting embodiments, a fiber glass strand of the present invention can comprise between twenty (20) and ten thousand (10,000) filaments per strand. In other non-limiting embodiments, a fiber glass strand of the present invention can comprise between two hundred (200) and four thousand five hundred (4,500) filaments per strand. The strands, in non-limiting examples, can be from 50 yards per pound to more than 18,000 yards per pound depending on the application. For some applications, such as filament winding, the strands can typically be between 250 yards per pound and 675 yards per pound, although other yields can be used.

The diameter of the filaments used in non-limiting embodiments of fiber glass strands of the present invention can be between, in general, between five (5) and eighty (80) microns. In some non-limiting embodiments, the diameter of the filaments can be between seven (7) and twenty-eight (28) microns. The diameter of the filaments, in some non-limiting embodiments, can be between thirteen (13) and twenty-four (24) microns.

Fiber glass strands at least partially coated with embodiments of sizing compositions of the present invention can be used in a number of different applications. One example of such an application is filament winding. Filament winding is a technique commonly used to manufacture a fiber-glass reinforced composite, often in the shape of a cylinder. Cylindrical filament wound composites can be used, for example, as pipes. Epoxy resins are commonly used in filament winding applications although persons of ordinary skill in the art will recognize that other resins might also be used.

In a typical filament winding operation, a plurality of fiber glass strands are coated with a matrix material (typically, including a thermosetting resin, one or more curing agents, and/or other additives) and then wound on a cylindrical mandrel in a predetermined pattern to a predetermined thickness. After winding, the pipe is then cured by heating for a given period of time. The mandrel is then removed.

There are two common types of filament winding processes: wet filament winding and dry filament winding. In wet filament winding, the strands go through a bath holding the matrix material and then pass through an orifice to remove excess matrix material from the strand. The “wet” strands are then wound on a mandrel and cured as described above. In dry filament winding, dry fiber glass strands are wound on a mandrel, and the matrix material is then applied to the strands on the mandrel. Different sizing compositions according to some embodiments of the present invention might be used depending on whether the fiber glass strand is to be used in a dry filament winding operation or a wet filament winding operation. Fiber glass strands of the present invention can be filament wound to form a reinforced pipe or other structure using techniques known to those of skill in the art.

In addition, persons of skill in the art can identify other applications for which fiber glass strands according to the present invention can be used. For example, fiber glass strands or rovings of the present invention can be woven into a fabric and then formed into a composite using pultrusion or hand lay-up techniques.

Some embodiments of the present invention relate to fiber glass reinforced composites. In some embodiments, a composite comprises a resin and a plurality of glass fibers at least partially coated with a sizing composition of the present invention. In general, any of the sizing compositions of the present invention can be used in such composites. In some embodiments, the resin to be reinforced is a thermosetting resin. In some further embodiments, the thermosetting resin comprises an epoxy. In some embodiments, a composite of the present invention is in the form of a pipe.

Some embodiments of the present invention relate to a pipe. In some embodiments, the pipe comprises a thermosetting resin and a plurality of glass fibers at least partially coated with a sizing composition of the present invention. The pipe can be formed by filament winding in some embodiments. In some embodiments, the thermosetting resin can comprise an epoxy.

Fiber glass reinforced composites of the present invention, in some embodiments, can have one or more desirable properties including, without limitation, desirable hydrolysis resistance (short and long term), desirable strength, interlaminar shear strength, and other properties relevant to the durability of the composites.

Embodiments of the present invention will now be illustrated in the following specific, non-limiting examples.

### EXAMPLES

Sizing compositions were prepared in accordance with the formulations set forth in Table 1 and Table 2. These formulations represent non-limiting embodiments of sizing compositions of the present invention. Formulation A is a non-limiting embodiment of a sizing compositions that can be used, for example, on glass fibers in wet or dry filament winding processes. Formulation B is a non-limiting embodiment of a sizing composition that can be used, for example, in wet filament winding processes. Formulation C is a non-limiting embodiment of a sizing composition that can be used, for example, on glass fibers in wet or dry filament winding processes.

TABLE 1

| | A (grams/ | | B (grams/ | |
|---|---|---|---|---|
| Component | 10 gal.) | | 10 gal.) | |
| Non-ionic Lubricant¹ | 194 | (2.651%) | 194 g (2.650%) | |
| Film-Former A² | 1025 | (4.200%) | 1220 | (5.000%) |
| Cationic Lubricant³ | 85 | (1.158%) | 42 | (0.570%) |
| Film-Former B⁴ | 4947 | (67.590%) | | |
| Emulsifying Agent A⁵ | 495 | (6.708%) | | |
| Emulsifying Agent B⁶ | 495 | (6.522%) | | |
| Emulsifying Agent C⁷ | 247 | (1.199%) | | |
| Film-Former C⁸ | | | 10216 | (78.170%) |
| Polyether Carbamate⁹ | 222 | (3.000%) | 111 | (1.500%) |
| Reactive Modified | | | 812 | (4.551%) |
| Siloxane Polymer¹⁰ | | | | |
| Alkylsilane¹¹ | 220 | (1.500%) | 306 | (2.088%) |
| Silane¹² | 462 g (5.171%) | | 461 g (5.170%) | |
| Siloxane¹³ | 58 | (0.300%) | 58 | (0.300%) |
| Antifoam¹⁴ | 2 | (0.003%) | 2 | (0.003%) |

| | | |
|---|---|---|
| Total Percent Solids | 18.9% | 18.9% |
| (Theoretical) | | |

¹Standapol 2661 polyethylene glycol monolaurate having an average molecular weight of 600 from Pulcra Chemicals.
²PVP K-30 polyvinylpyrrolidone from ISP Chemicals of Wayne, NJ.
³Katax 6717L partially amidated polyethylene imine from Pulcra Chemicals.
⁴EPON 880 epoxy resin from Momentive Specialty Chemicals Inc.
⁵Pluronic F-108 polyoxyalkylene block copolymer from BASF Corp.
⁶Alkamuls EL-719 ethoxylated castor oil from Rhodia.
⁷Lutensol OP-10 octylphenol ethoxylate from BASF Corp.
⁸EPI-REZ 3514-W56 aqueous dispersion of an epoxy resin having an epoxy equivalent weight of 205-225 g/eq from Momentive Specialty Chemicals Inc.
⁹Reaction produt of a polyoxyalkylene diamine and a propylene carbonate.
¹⁰COATOSIL 9300 organomodified polydimethylsiloxane emulsion from Momentive Performance Materials Inc.
¹¹DYNAYLAN SIVO 850 alkyltriethoxy silane from Evonik Industries, Inc.
¹²DYNASYLAN ® GLYMO 3-glycidyloxypropyltrimethoxysilane from Evonik Industries, Inc.
¹³HYDROSIL ® 2909 from Evonik Industries, Inc.
¹⁴SAG-10 silicone antifoam emulsion from Momentive Specialty Chemicals Inc.

TABLE 2

| | A (grams/ | | B (grams/ | | C (grams/ | |
|---|---|---|---|---|---|---|
| Component | 10 gal.) | | 10 gal.) | | 10 gal.) | |
| Non-ionic | 194 | (2.651%) | 194 | (2.650%) | | |
| Lubricant A¹⁵ | | | | | | |
| Non-ionic | | | | | 733 | (5.000%) |
| Lubricant B¹⁶ | | | | | | |
| Non-ionic | | | | | 218 | (0.950%) |
| Lubricant C¹⁷ | | | | | | |
| Film-Former A¹⁸ | 1025 | (4.200%) | 1220 | (5.000%) | | |
| Cationic | 85 | (1.158%) | 42 | (0.570%) | 85 | (1.158%) |
| Lubricant¹⁹ | | | | | | |
| Film-Former B²⁰ | 4947 | (67.590%) | | | | |
| Emulsifying | 495 | (6.708%) | | | | |
| Agent A²¹ | | | | | | |
| Emulsifying | 495 | (6.522%) | | | | |
| Agent B²² | | | | | | |
| Emulsifying | 247 | (1.199%) | | | | |
| Agent C²³ | | | | | | |
| Film-Former C²⁴ | | | 10216 | (78.170%) | 9849 | (75.290) |
| Film-Former D²⁵ | | | | | 621 | (5.000%) |
| Polyether | 222 | (3.000%) | 111 | (1.500%) | 192 | (2.600%) |
| Carbamate²⁶ | | | | | | |
| Reactive | | | 812 | (4.551%) | | |
| Modified | | | | | | |
| Siloxane | | | | | | |
| Polymer²⁷ | | | | | | |
| Alkylsilane A²⁸ | 220 | (1.500%) | 306 | (2.088%) | | |
| Alkylsilane B²⁹ | | | | | 206 | (2.088%) |
| Silane A³⁰ | 462 | (5.171%) | 461 | (5.170%) | 551 | (6.170%) |
| Silane B³¹ | | | | | 206 | (1.741%) |
| Siloxane³² | 58 | (0.300%) | 58 | (0.300%) | | |
| Antifoam³³ | 2 | (0.003%) | 2 | (0.003%) | 2 | (0.003%) |

| | | | |
|---|---|---|---|
| Total Percent | 18.9% | 18.9% | 18.9% |
| Solids | | | |
| (Theoretical) | | | |

¹⁵Standapol 2661 polyethylene glycol monolaurate having an average molecular weight of 600 from Pulcra Chemicals.
¹⁶Lurol 14330 emulsion from Goulston Technologies, Inc.
¹⁷Michem Lube 723 nonionic paraffin wax emulsion from Michelman, Inc.
¹⁸PVP K-30 polyvinylpyrrolidone from ISP Chemicals of Wayne, NJ.
¹⁹Katax HGBB partially amidated polyethylene imine from Pulcra Chemicals.
²⁰EPON 880 epoxy resin from Momentive Specialty Chemicals Inc.
²¹Pluronic F-108 polyoxyalkylene block copolymer from BASF Corp.
²²Alkamuls EL-719 ethoxylated castor oil from Rhodia.
²³Lutensol OP-10 octylphenol ethoxylate from BASF Corp.
²⁴EPI-REZ 3514-W56 aqueous dispersion of an epoxy resin having an epoxy equivalent weight of 205-225 g/eq from Momentive Specialty Chemicals Inc.
²⁵EPI-REZ 5520-W-60 aqueous dispersion of an epoxy resin having an epoxy equivalent weight of 480-560 g/eq from Momentive Specialty Chemicals Inc.
²⁶Reaction produt of a polyoxyalkylene diamine and a propylene carbonate.
²⁷COATOSIL 9300 organomodified polydimethylsiloxane emulsion from Momentive Performance Materials Inc.
²⁸DYNAYLAN SIVO 850 alkyltriethoxy silane from Evonik Industries, Inc.
²⁹DYNAYLAN PTMO alkyltriethoxy silane from Evonik Industries, Inc.
³⁰DYNASYLAN GLYMO 3-glycidyloxypropyltrimethoxysilane from Evonik Industries, Inc.
³¹DYNASYLAN AMEO 3-aminopropyltriethoxysilane from Evonik Industries, Inc.
³²HYDROSIL 2909 from Evonik Industries, Inc.
³³SAG-10 silicone antifoam emulsion from Momentive Specialty Chemicals Inc.

### Preparation of Sizing Compositions

To prepare Sizing Composition A, deionized water (60-90° F.) (4.5 liters per 10 gallons of desired sizing composition) was added to a main mix tank. Hot water (˜150° F.) (0.7 liters per 10 gallons of desired sizing composition) was added to a premix tank. The specified amount of Non-Ionic Lubricant was added to the water in the premix tank, agitated for five minutes at a moderate speed, and then transferred to the main mix tank. The specified amount of Film-Former A was then added to the main mix tank.

The specified amount of Cationic Lubricant was added to a premix bucket and hot water (˜150° F.) (0.4 liters per 10 gallons of desired sizing composition) was added. The premix bucket was agitated for 15 minutes and then transferred to the main mix tank.

The specified amounts of Film-Former B, Emulsifying Agent A, Emulsifying Agent B, and Emulsifying Agent C were added to an Eppenbach tank. The Eppenbach mixer and the lightning mixer were then started and the tank was heated to ˜150° F. Once that temperature was reached and the ingredients were mixed thoroughly, ˜3 liters of hot water (˜150° F.) was added to the Eppenbach tank using a 1.0 gallon/minute water system until inversion occurred. The lighting mixer remained on, and the Eppenbach baffle plate was adjusted to ensure the best inversion. Following inversion, sufficient hot water (˜150° F.) was added to double the volume of the emulsion to ˜12 liters. The emulsion was then transferred to the main mix tank.

The specified amount of Polyether Carbamate was then added directly to the main mix tank. The specified amount of Alkylsilane was then added directly to the main mix tank.

To prepare the Silane, deionized water (˜75° F.) (9 liters per 10 gallons of desired sizing composition) was added to a premix tank. The agitator was turned on and acetic acid (61 milliliters per 10 gallons of desired sizing composition) was added. The Silane was then slowly added to the premix tank. The solution was agitated for 30 minutes until the solution was complete. The Silane solution was then transferred to the main mix tank.

The specified amount of Siloxane was then added to the main mix tank followed by the specified amount of Antifoam. The main mix tank was then agitated while enough cold water (˜75° F.) was added to bring the sizing composition to its desired volume. After agitating for at least 15 minutes further, the sizing composition was tested to make sure it met the target percent solids (18.9% and pH (4.6).

To prepare Sizing Composition B, deionized water (60-90° F.) (4.5 liters per 10 gallons of desired sizing composition) was added to a main mix tank. Hot water (˜150° F.) (0.7 liters per 10 gallons of desired sizing composition) was added to a premix tank. The specified amount of Non-Ionic Lubricant was added to the water in the premix tank, agitated for five minutes at a moderate speed, and then transferred to the main mix tank. The specified amount of Film-Former A was then added to the main mix tank.

The specified amount of Cationic Lubricant was added to a premix bucket and hot water (˜150° F.) (0.4 liters per 10 gallons of desired sizing composition) was added. The premix bucket was agitated for 15 minutes and then transferred to the main mix tank.

The specified amount of Film-Former C was then added directly to the main mix tank. The specified amount of Polyether Carbamate was then added directly to the main mix tank. The specified amount of the Reactive Modified Siloxane Polymer was then added directly to the main mix tank. The specified amount of Alkylsilane was then added directly to the main mix tank.

To prepare the Silane, deionized water (˜75° F.) (9 liters per 10 gallons of desired sizing composition) was added to a premix tank. The agitator was turned on and acetic acid (61 milliliters per 10 gallons of desired sizing composition) was added. The Silane was then slowly added to the premix tank. The solution was agitated for 30 minutes until the solution was complete. The Silane solution was then transferred to the main mix tank.

The specified amount of Siloxane was then added to the main mix tank followed by the specified amount of Antifoam. The main mix tank was then agitated while enough cold water (˜75° F.) was added to bring the sizing composition to its desired volume. After agitating for at least 15 minutes further, the sizing composition was tested to make sure it met the target percent solids (18.9%) and pH (4.6).

To prepare Sizing Composition C, deionized water (60-90° F.) (4.5 liters per 10 gallons of desired sizing composition) was added to a main mix tank.

To prepare the Silane A and Alkylsilane B, deionized water (˜75° F.) (9 liters per 10 gallons of desired sizing composition) was added to a premix tank. The agitator was turned on and acetic acid (69 milliliters per 10 gallons of desired sizing composition) was added. The Silane A was then slowly added to the premix tank. The solution was agitated for 30 minutes before Alkylsilane B was slowly added to the premix tank. The solution was agitated for 30 more minutes until the solution was complete. The silane solution was then transferred to the main mix tank.

To prepare the Silane B, deionized water (˜75° F.) (4 liters per 10 gallons of desired sizing composition) was added to a premix tank. The agitator was turned on and acetic acid (54 milliliters per 10 gallons of desired sizing composition) was added. The Silane B was then slowly added to the premix tank. The solution was agitated for 30 minutes until the solution was complete. The silane solution was then transferred to the main mix tank.

The specified amount of Cationic Lubricant was added to a premix bucket and hot water (˜150° F.) (0.4 liters per 10 gallons of desired sizing composition) was added. The premix bucket was agitated for 15 minutes and then transferred to the main mix tank.

The specified amount of Film-Former C was then added directly to the main mix tank. The specified amount of Film-Former D was then added directly to the main mix tank.

The specified amount of Non-Ionic Lubricant B was then added directly to the main mix tank. The specified amount of Non-Ionic Lubricant C was then added directly to the main mix tank.

The specified amount of Polyether Carbamate was then added directly to the main mix tank followed by the specified amount of Antifoam.

The main mix tank was then agitated while enough cold water (˜75° F.) was added to bring the sizing composition to its desired volume. After agitating for at least 15 minutes further, the sizing composition was tested to make sure it met the target percent solids (18.9%) and pH (4.7).

Measurement of Inter-Laminar Shear Strength

Each of the sizing compositions in Tables 1 and 2 was applied to fiber glass strands. Additionally, two commerically available sizing compositions (rovings) were also applied to fiber glass strands. The sizing compositions were applied to the glass filaments during the fiber glass forming process when the newly formed glass filaments contacted directly a sizing application device. A fiber glass strand containing up to 4,000 filaments was then wound onto the mandrel of a winder to form a roving package. After being removed from the mandrel of the winder and dried in an oven, the roving package can then be used as the reinforcement material in composites fabrication processes including filament winding. The amount of sizing applied on glass fiber strands is measured as LOI (Loss Of Ignition). Typical nominal LOI values are in the range of 0.40%-0.80%. Typical nominal fiber diameter of a fiber glass roving strand for filament winding is in the range of 10-30 nm. Typical nominal roving linear density for filament winding applications is in the range of 600-4,500 TEX.

Fiber glass rovings coated with the sizing compositions in Tables 1 and 2 as well as two commercially available sizing compositions were used to fabricate glass fiber reinforced epoxy composite cylinders with filament winding process for Inter-Laminar Shear Strength (ILSS) testing. During filament winding, a single roving strand unwound from a roving package was pulled through a tensioning device and then into a resin bath to saturate with epoxy resin and then wound onto a 6-inch mandrel at a winding angle of 86-88 degrees to form a composite cylinder. The epoxy resin (D.E.R. 383) used for the composite cylinder fabrication was mixed with a cycloaliphatic amine hardener (VESTAMIN IPD) at a ratio of 100:22. After curing and post-curing, the composite cylinder was cut into ILSS specimens with dimensions specified in ASTM D2344 (“Standard Test Method for Short-Beam Strength of Polymer Matrix Composite Materials and Their Laminates”). The ILSS testing was conducted at the PPG Fiber Glass Science and Technology Center in Shelby, N.C. per the procedure specified in ASTM D2344 test method. The results of these tests are provided in Table 3.

As is shown in Table 3, ILSS data can be used as an indicator for fiber-matrix interfacial bonding strength and durability. It is important to reach certain level of ILSS value under dry conditions and without ageing to ensure adequate initial fiber-matrix bonding strength. Since a fiber glass reinforced epoxy pipe is typically used in wet conditions under internal pressure, it is equally important to have a durable fiber-matrix interface in this kind of corrosive environment. Higher retained ILSS values after 1,000-hour ageing in hot water is an indication of improved interfacial hydrolysis resistance for Sizing Compositions A, B and C over the two commercial sizing compositions as shown in Table 3.

TABLE 3

| | ILSS | ILSS | | | | | |
|---|---|---|---|---|---|---|---|
| Inter-Laminar | Specimen | Specimen | | | | | |
| Shear | Ageing | Ageing | | | | | |
| Strength | Time in | Temperature | | | | | |
| (ILSS) Test | H₂O | in H₂O | ILSS Sample Descriptions³⁴ | | | | |
| Items | (hours) | (° C.) | Commercial 1 | Commercial 2 | Formulation A | Formulation B | Formulation C |
| Average | 0 | 96 | 8.25 | 8.27 | 7.23 | 8.15 | 8.01 |
| ILSS (kpsi) | | | | | | | |
| COV (%) of | 0 | 96 | 4.81 | 4.24 | 6.36 | 7.15 | 3.15 |
| ILSS | | | | | | | |
| Average | 24 | 96 | 7.79 | 7.80 | 7.33 | 7.64 | 7.06 |
| ILSS (kpsi) | | | | | | | |
| COV (%) of | 24 | 96 | 4.63 | 5.16 | 5.63 | 10.98 | 7.07 |
| ILSS | | | | | | | |
| Average | 168 | 96 | 5.93 | 5.32 | 6.51 | 5.78 | 7.00 |
| ILSS (kpsi) | | | | | | | |
| COV (%) of | 168 | 96 | 4.12 | 6.79 | 7.03 | 9.34 | 1.77 |
| ILSS | | | | | | | |
| Average | 1008 | 96 | 4.51 | 5.27 | 5.46 | 6.21 | 6.23 |
| ILSS (kpsi) | | | | | | | |
| COV (%) of | 1008 | 96 | 6.53 | 6.54 | 11.03 | 4.54 | 2.21 |
| ILSS | | | | | | | |
| Glass | | | 65.2 | 64.7 | 74.2 | 71.6 | 74.0 |
| Content (%) | | | | | | | |

³⁴Test standard: ASTM D2344
Resin: D.E.R. 383 Epoxy Resin
Hardener: VESTAMIN IPD cycloaliphatic diamine

Desirable characteristics, which can be exhibited by the present invention, include, but are not limited to, the provision of sizing compositions that can be useful on glass fibers to be used in filament winding process (wet and/or dry); the provision of fiber glass strands coated with a sizing composition that are adapted for use in filament winding processes; the provision of fiber glass strands that can be processed with acceptable break levels during downstream processing; the provision of fiber glass strands that can exhibit a desired tensile strength; the provision of fiber glass strands that can be used in the reinforcement of a composite having desirable properties (e.g., strength, hydrolysis resistance, etc.); and others.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

1. A sizing composition for glass fibers, comprising:
a polyether carbamate.

2. The sizing composition of claim 1, wherein the polyether carbamate comprises at least about 1% of the sizing composition on a total solids basis.

3. The sizing composition of claim 1, wherein the polyether carbamate comprises at least about 1.5-3% of the sizing composition on a total solids basis.

4. The sizing composition of claim 1, wherein the polyether carbamate comprises less than about 15 weight percent of the total sizing composition.

5. The sizing composition of claim 1, wherein the polyether carbamate comprises less than about 5 weight percent of the total sizing composition.

6. The sizing composition of claim 1, wherein the polyether carbamate comprises a reaction product of a polyoxyalkylene amine and a carbonate.

7. The sizing composition of claim 6, wherein the polyoxyalkylene amine comprises polyoxyalkylene diamine.

8. The sizing composition of claim 7, wherein the polyoxyalkylene diamine comprises a compound having the following structure (I):
H2N[R¹—O]ₙ[R³—O]ₘ—R²—NH₂
wherein each R¹, R², and R³ can be the same or different and each can independently represent a C₂ to C₁₂ alkylene group, and wherein (n+m) is a value greater than 2.

9. The sizing composition of claim 6, wherein the polyoxyalkylene amine comprises polyetheramine.

10. The sizing composition of claim 9, wherein the carbonate comprises propylene carbonate.

11. The sizing composition of claim 10, wherein the carbonate comprises cyclic propylene carbonate.

12. The sizing composition of claim 1, further comprising an aminofunctional oligomeric siloxane.

13. The sizing composition of claim 12, where the aminofunctional oligomeric siloxane comprises at least one alkyl group bonded to a first silicon atom and at least one amine bonded to a second silicon atom.

14. The sizing composition of claim 12, wherein the siloxane comprises at least 0.1 percent by weight of the sizing composition on a total solids basis.

15. The sizing composition of claim 1, further comprising an alkylsilane.

16. The sizing composition of claim 15, wherein the alkylsilane comprises a straight chain segment of at least 3 carbon atoms.

17. The sizing composition of claim 16, wherein the alkylsilane comprises propyltrimethoxysilane.

18. The sizing composition of claim 15, wherein the alkylsilane comprises at least 1 percent by weight of the sizing composition on a total solids basis.

19. The sizing composition of claim 1, further comprising a reactive modified siloxane polymer.

20. The sizing composition of claim 19, wherein the reactive modified siloxane polymer is an organomodified dimethylsiloxane polymer.

21. The sizing composition of claim 19, wherein the reactive modified siloxane polymer is an epoxy functionalized siloxane polymer.

22. The sizing composition of claim 19, wherein the reactive modified siloxane polymer comprises at least 0.1 percent by weight of the sizing composition on a total solids basis.

23. The sizing composition of claim 1, further comprising at least one film former.

24. The sizing composition of claim 23, wherein the at least one film former comprises an epoxy film former.

25. A plurality of glass fibers at least partially coated with the sizing composition of claim 1.

26. A fiber glass roving comprising a plurality of glass fibers at least partially coated with the sizing composition of claim 1.

27. A sizing composition for glass fibers, comprising:
a polyether carbamate;
an alkylsilane; and
an aminofunctional siloxane.

28. The sizing composition of claim 27, wherein the polyether carbamate comprises at least about 1.5% of the sizing composition on a total solids basis.

29. The sizing composition of claim 27, wherein the polyether carbamate comprises a reaction product of a polyoxyalkylene amine and a carbonate.

30. The sizing composition of claim 29, wherein the polyoxyalkylene amine comprises polyoxyalkylene diamine.

31. The sizing composition of claim 30, wherein the polyoxyalkylene diamine comprises a a compound having the following structure (I):
H2N[R¹—O]ₙ[R³—O]ₘ—R²—NH₂
wherein each R¹, R², and R³ can be the same or different and each can independently represent a C₂ to C₁₂ alkylene group, and wherein (n+m) is a value greater than 2.

32. The sizing composition of claim 31, wherein the polyoxyalkylene amine comprises polyetheramine.

33. The sizing composition of claim 32, wherein the carbonate comprises propylene carbonate.

34. The sizing composition of claim 33, wherein the carbonate comprises cyclic propylene carbonate.

35. The sizing composition of claim 27, where the aminofunctional oligomeric siloxane comprises at least one alkyl group bonded to a first silicon atom and at least one amine bonded to a second silicon atom.

36. The sizing composition of claim 27 wherein the siloxane comprises at least 0.1 percent by weight of the sizing composition on a total solids basis.

37. The sizing composition of claim 27, wherein the alkylsilane comprises a straight chain segment of at least 3 carbon atoms.

38. The sizing composition of claim 27, wherein the alkylsilane comprises at least 1.5 percent by weight of the sizing composition on a total solids basis.

39. The sizing composition of claim 27, further comprising a reactive modified siloxane polymer.

40. The sizing composition of claim 39, wherein the reactive modified siloxane polymer comprises at least 0.1 percent by weight of the sizing composition on a total solids basis.

41. A plurality of glass fibers at least partially coated with the sizing composition of claim 27.

42. A fiber glass roving comprising a plurality of glass fibers at least partially coated with the sizing composition of claim 27.

43. A sizing composition for glass fibers, comprising:
a polyether carbamate in an amount of at least 1.5 weight percent of the sizing composition on a total solids basis;
an alkylsilane in an amount of at least 1.5 weight percent of the sizing composition on a total solids basis; and
an aminofunctional siloxane in an amount of at least 0.1 weight percent of the sizing composition on a total solids basis.
